(19) United States
(12) Patent Application Publication
(10) Pub. No.: US 2023/0273768 A1
(43) Pub. Date: Aug. 31, 2023

(54) FLOATING-POINT CALCULATION METHOD AND ASSOCIATED ARITHMETIC UNIT

(71) Applicant: National Tsing Hua University, Hsinchu City (TW)

(72) Inventors: Jun-Shen Wu, Hsinchu City (TW); Ren-Shuo Liu, Hsinchu City (TW)

(21) Appl. No.: 18/104,311

(22) Filed: Feb. 1, 2023

Related U.S. Application Data
(60) Provisional application No. 63/305,711, filed on Feb. 2, 2022.

(30) Foreign Application Priority Data
Feb. 1, 2023 (TW) 112103523

(51) Int. Cl. G06F 7/487

(52) U.S. Cl. CPC G06F 7/4876

(57) ABSTRACT

A floating-point number operation method applied to multiplication operation of a first floating-point number and a second floating-point number is provided. The first floating point number includes a first symbol, a first exponent and a first mantissa. The second floating point number includes a second symbol, a second exponent and a second mantissa. The method includes using an arithmetic unit to perform: comparing the first exponent to an exponent threshold, wherein when the first exponent is not less than the exponent threshold, generating a mantissa operation result by multiplying the first mantissa and the second mantissa when the first exponent is not less than the exponent threshold value; and generating a calculated floating point number according to the mantissa operation result and an exponent operation result of the first exponent and the second exponent.

### FIELD OF THE INVENTION

The invention relates to applications of floating-point operations, and more particularly, to floating-point calculation method and an associated arithmetic unit.

### BACKGROUND OF THE INVENTION

With the increasing development of the machine learning techniques, the loading of floating-point operations has become greater and greater. Hence, how to compress the large amount of floating-point data to increase operation speed and reduce power consumption has become a hot issue for those in the field to study. Existing floating-point techniques mostly adopt uniform coding and operations, which leads to an overdesign that wastes storage space due to storing unnecessary data, thereby increasing transmission time and power consumption.

In view of the above, there is a need for a novel floating-point calculation method and an associated hardware architecture to solve the above-mentioned problem encountered in related art techniques.

### SUMMARY OF THE INVENTION

According to the above requirements, one of the purposes of the present invention is to provide an efficient floating-point coding and calculation method to solve the problems encountered in conventional floating-point operations, without greatly increasing the cost, and thereby improve the operation speed and reduce the power consumption.

An embodiment of the present invention provides a floating-point calculation method applicable to multiplication between a first register and a second register. The first register stores a first floating point number, and the second register stores a second floating point number. The first register comprises a first exponent bit(s) storing a first exponent, and a first mantissa bit(s) storing a first mantissa. The second register comprises a second exponent bit(s) storing a second exponent, and a second mantissa bit(s) storing a second mantissa. The method comprises using an arithmetic unit to perform following steps: comparing the first exponent with an exponent threshold, wherein when the first exponent is not smaller than the exponent threshold, the first mantissa is multiplied by the second mantissa to generate a mantissa operation result; and when the first exponent is smaller than the exponent threshold, the first mantissa is multiplied by the second mantissa after at least one bit of the first mantissa is discarded, to generate the mantissa operation result; adding the first exponent to the second exponent to generate an exponent operation result; and generating a calculated floating point number according to the mantissa operation result and the exponent operation result.

In addition to the above method, another embodiment of the present invention provides an arithmetic unit coupled to a first register and a second register. The first register stores a first floating point number, and the second register stores a second floating point number. The first register comprises a first exponent bit(s) storing a first exponent, and a first mantissa bit(s) storing a first mantissa. The second register comprises a second exponent bit(s) storing a second exponent, and a second mantissa bit(s) storing a second mantissa. When performing multiplication between the first register and the second register, the arithmetic unit performs following steps: comparing the first exponent with an exponent threshold, wherein when the first exponent is not smaller than the exponent threshold, the first mantissa is multiplied by the second mantissa to generate a mantissa operation result; and when the first exponent is smaller than the exponent threshold, the first mantissa is multiplied by the second mantissa after at least one bit of the first mantissa is discarded to generate the mantissa operation result; adding the first exponent to the second exponent to generate an exponent operation result; and generating a calculated floating point number according to that mantissa operation result and the exponent operation result.

Another embodiment of the present invention provides an arithmetic device comprising a first register, a second register and an arithmetic unit. The arithmetic unit is coupled to the first register and the second register, and the first register stores a first floating point number and the second register stores a second floating point number. The first register comprises a first exponent bit(s) storing a first exponent, and a first mantissa bit(s) storing a first mantissa. The second register comprises a second exponent bit(s) storing a second exponent, and a second mantissa bit(s) storing a second mantissa; wherein when performing multiplication between the first register and the second register, the arithmetic unit performs following steps: comparing the first exponent with an exponent threshold, wherein when the first exponent is not smaller than the exponent threshold, the first mantissa is multiplied by the second mantissa to generate a mantissa operation result; when the first exponent is smaller than the exponent threshold, the first mantissa is multiplied by the second mantissa after at least one bit of the first mantissa is discarded, to generate the mantissa operation result; adding the first exponent to the second exponent to generate an exponent operation result; and generating a calculated floating point number according to the mantissa operation result and the exponent operation result.

Selectively, according to an embodiment of the present invention, the exponent threshold is stored in a third register, and the arithmetic unit accesses the third register when performing multiplication between the first register and the second register.

Selectively, according to an embodiment of the present invention, the first register further comprises a first sign bit storing a first sign, the second register further comprises a second sign bit storing a second sign. The floating-point calculation method further comprises: performing an XOR operation upon the first sign and the second sign to generate a sign operation result; and generating the calculated floating point number according to the mantissa operation result, the sign operation result and the exponent operation result.

Selectively, according to an embodiment of the present invention, when the first exponent is smaller than the exponent threshold, at least one bit of the first mantissa is temporarily stored but not used in arithmetic operations.

Selectively, according to an embodiment of the present invention, the exponent threshold is dynamically adjustable.

Selectively, according to an embodiment of the present invention, the exponent threshold is dynamically adjusted according to temperature of the arithmetic unit and/or types of tasks to be processed by the arithmetic unit.

Selectively, according to an embodiment of the present invention, the exponent threshold is within a dynamically adjustable range, and the arithmetic unit starts training with an exponent threshold with a value of 1. The arithmetic unit determines a criteria whether an operation precision is higher than a precision threshold. If the criteria is met, the value of the exponent threshold is increased until the operation precision is not higher than a precision threshold, and the dynamically adjustable range is presented by the exponent threshold that meets the criteria.

Selectively, according to an embodiment of the present invention, the first register is coupled to a memory arranged to store a first exponent. When the first exponent is smaller than the exponent threshold, at least one bit of the first mantissa is discarded without being stored in the memory.

Selectively, according to an embodiment of the present invention, when the first exponent is smaller than the exponent threshold, at least one bit of the first mantissa is in a Don’t Care state.

Selectively, according to an embodiment of the present invention, when the first exponent is smaller than the exponent threshold, the first floating point number is decoded into (-1)^{Signl} × 2^{Exponent1,} where Sign1 denotes the first sign, and Exponent1 denotes the first exponent.

Selectively, according to an embodiment of the present invention, when the second exponent is smaller than the exponent threshold, the second floating point number is decoded into (-1)^{Sign2} × 2^{Exponent2}, where Sign2 denotes the second sign, and Exponent2 denotes the second exponent.

Selectively, according to an embodiment of the present invention, the arithmetic unit is further used to access a memory that is arranged to store a plurality of groups of batch normalization coefficients corresponding to a plurality of candidate thresholds respectively, and the exponent threshold is selected from one of the candidate thresholds. Batch normalization coefficient is a kind of coefficient for adjusting the average and standard deviation of numerical values in artificial intelligence (AI) operations. Generally, a piece of numerical data of a feature map corresponds to a set of specific batch normalization coefficients. According to this embodiment, the operation process of a piece of numerical data of a feature map may vary due to different the exponent threshold, and the way the mantissa is discarded may also be different. Taking the above factors into account, the present invention correspondingly provides a plurality of groups of batch normalization coefficients.

In view of the above, once the exponent value of a floating point number is smaller than the threshold value, the present invention may discard the mantissa to further save storage space. Further, the present invention may just store the mantissa, without the mantissa involving in decoding or operations, to further save the time and effort for data transmission and reduce the power consumption of the operations. In addition, through the adjustability of the threshold, the corresponding electronic product can flexibly make a tradeoff between the high-performance mode and the low-power mode, so that the present invention can save power consumption and increase the processing speed under while keeping the required operation precision.

### BRIEF DESCRIPTION OF THE DRAWINGS

FIG. 1 is a diagram illustrating an arithmetic unit applied to an arithmetic device according to an embodiment of the present invention.

FIG. 2 is a diagram illustrating a register storing a floating point number according to a related art technique.

FIG. 3 is a diagram illustrating a register storing a floating point number according to an embodiment of the present invention.

FIG. 4 is a diagram illustrating the architecture of an arithmetic unit for multiplying two floating point numbers according to the present invention.

FIG. 5 is a flowchart of an arithmetic unit training an artificial intelligence model according to an embodiment of the present invention.

FIG. 6 is a flowchart illustrating an arithmetic device for reducing the power consumption of a processing chip according to an embodiment of the present invention.

FIG. 7 is a flowchart illustrating an arithmetic device adaptively adjusting the power consumption of a processing chip while the precision is maintained, according to an embodiment of the present invention.

FIG. 8 is a flowchart illustrating a floating-point calculation method according to an embodiment of the present invention.

### DETAILED DESCRIPTION OF PREFERRED EMBODIMENTS

The present disclosure is particularly described by following examples that are mainly for illustrative purposes. For those who are familiar with the technologies, various modifications and embellishments can be made without departing from the spirit and scope of the present disclosure, and thus the scope of the present disclosure shall be subject to the content of the attached claims. In the entire specification and claims, unless clearly specified, terms such as “a/an” and “the” can be used to describe “one or at least one” assembly or component. In addition, unless the plural use is obviously excluded in the context, singular terms may also be used to present plural assemblies or components. Unless otherwise specified, the terms used in the entire specification and claims generally have the common meaning as those used in this field. Certain terms used to describe the disclosure will be discussed below or elsewhere in this specification, so as to provide additional guidance for practitioners. The examples throughout the entire specification as well as the terms discussed herein are only for illustrative purposes, and are not meant to limit the scope and meanings of the disclosure or any illustrative term. Similarly, the present disclosure is not limited to the embodiments provided in this specification.

The terms “substantially”, “around”, “about” or “approximately” used herein may generally mean that the error of a given value or range is within 20%, preferably within 10%. In addition, the quantity provided herein can be approximate, which means that unless otherwise stated, it can be expressed by the terms “about”, “nearly”, etc. When the quantity, concentration, or other values or parameters have a specified range, a preferred range, or upper and lower boundaries listed in the table, they shall be regarded as a particular disclosure of all possible combinations of ranges constructed by those upper and lower limits or ideal values, no matter such kind of ranges have been disclosed or not. For example, if the length of a disclosed range is X cm to Y cm, it should be regarded as that the length is H cm, and H can be any real number between x and y.

In addition, the term “electrical coupling” or “electrical connection” may include direct and indirect means of electrical connection. For example, if the first device is described as electrically coupled to the second device, it means that the first device can be directly connected to the second device, or indirectly connected to the second device through other devices or means of connection. In addition, if the transmission and provision of electric signals are described, those who are familiar with the art should understand that the transmission of electric signals may be accompanied by attenuation or other non-ideal changes. However, unless the source and receiver of the transmission of electric signals are specifically stated, they should be regarded as the same signal in essence. For example, if the electrical signal S is transmitted from the terminal A of the electronic circuit to the terminal B of the electronic circuit, which may cause voltage drop across the source and drain terminals of the transistor switch and/or possible stray capacitance, but the purpose of this design is to achieve some specific technical effects without deliberately using attenuation or other non-ideal changes during transmission, the electrical signals S at the terminal A and the terminal B of the electronic circuit should be substantially regarded as the same signal.

The terms “comprising”, “having” and “involving” used herein are open-ended terms, which can mean “comprising but not limited to”. In addition, the scope of any embodiment or claim of the present invention does not necessarily achieve all the purposes, advantages or features disclosed in the present invention. In addition, the abstract and title are only used to assist the search of patent documents, and are not used to limit the scope of claims of the present invention.

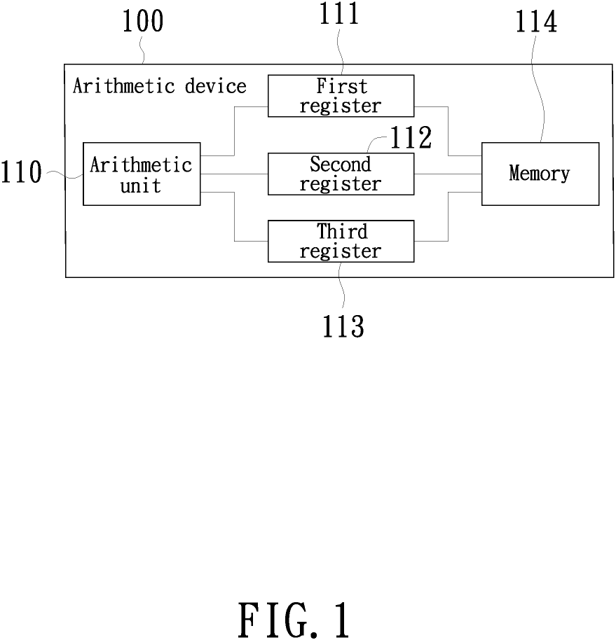

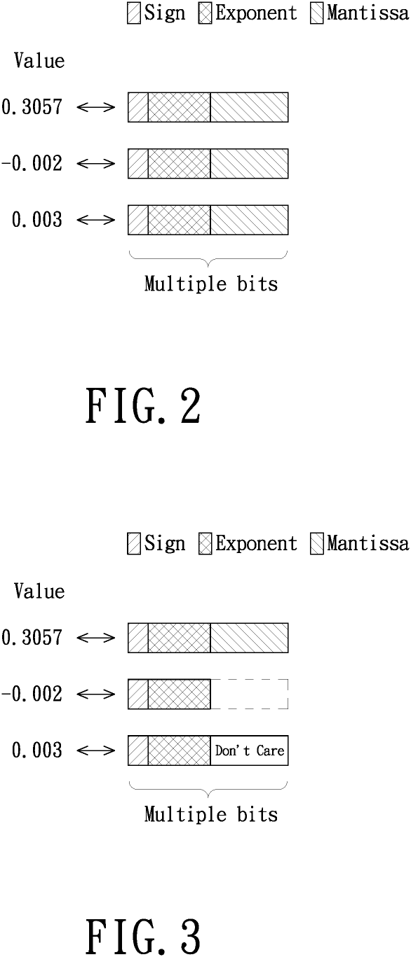

Please refer to FIG. 1, which is a diagram illustrating an arithmetic unit 110 applied to an arithmetic device 100 according to an embodiment of the present invention. As shown in FIG. 1, the arithmetic device 100 comprises an arithmetic unit 110, a first register 111, a second register 112, a third register 113 and a memory 114. The arithmetic unit 110 is coupled to the first register 111, the second register 112 and the third register 113. The memory 114 is coupled to the first register 111, the second register 112 and the third register 113. Note that the memory 114 here is used to overall describe the memory units in the arithmetic device 100, that is, the memory 114 can be an independent memory cell, or all possible memory cells in the arithmetic device 100. For example, the first register 111, the second register 112 and the third register 113 may be coupled to different memories. The arithmetic device 100 can be any device with computing capability, such as a central processing unit (CPU), a graphics processor (GPU), an artificial intelligence (AI) accelerator, a programmable logic array (FPGA), a desktop computer, a notebook computer, a smart phone, a tablet computer, a smart wearable device, etc. Under some conditions, the mantissas of floating point numbers (also referred to as “floating points”) stored in the first register 111 and the second register 112 can be discarded by the present invention without being stored in the memory 114, thereby saving memory space. In addition, the memory 114 can store a plurality of groups of batch normalization coefficients respectively correspond to a plurality of candidate thresholds, and the exponent threshold is selected from one of the candidate thresholds. The batch normalization coefficient is a kind of coefficient for adjusting the average and standard deviation of numerical values in AI operations. Generally, a piece of numerical data of a feature map corresponds to a set of specific batch normalization coefficients. According to this embodiment, the way the mantissas are discarded during processing a piece of numerical data of a feature map may be different due to adopting a different exponent threshold. Hence, the present invention can correspondingly provide a plurality of groups of batch normalization coefficients to deal with the above situation. The first register 111 is used to store the first floating point number, the second register 112 is used to store the f second floating point number, and the third register 113 is used to store an exponent threshold. When the first register 111 and the second register 112 perform operations, the third register 113 is accessed so as to read the exponent threshold value. For example, please refer to FIG. 2, which is a diagram illustrating floating point numbers stored in a register according to a prior art technique. As shown in FIG. 2, a floating point number is divided into a sign, exponent and mantissa to be stored in three different columns of a register. During a decoding process, the floating point number may be decoded as the following equation:

$${\left(\text{-1}\right)}^{\text{Sign}} \times 1. \text{Mantissa} \times {\text{2}}^{\text{Exponent}}$$

where Sign denotes the sign of the floating point number and Exponent denotes the exponent of the floating point number. In general, the leftmost bit of the register is allocated as a sign bit to store the sign, while the remaining bits (e.g., the remaining 7 – 63 bits) are allocated as exponent bits and mantissa bits to store the exponent and mantissa respectively. In the example of FIG. 2, the total number of the sign bit, exponent bits and mantissa bits can be 8 - 64 bits, but the present invention is not limited thereto. In another example of the present invention, the sum of the sign bit, exponent bits and mantissa bits may also be smaller than 8 bits, e.g., 7 bits.

Next, please refer to FIG. 3, which is a diagram illustrating a register storing floating point numbers according to an embodiment of the present invention. In this invention, the exponent bit of a floating point number is compared with an exponent threshold, and the processing mode for mantissas of floating point numbers is selected mainly by setting an exponent threshold. As shown in FIG. 3, under Float 32, a decimal value “0.3057” is converted into a binary value “00111110100111001000010010110110”, in which the first bit from the most significant bit stores “0” to indicate the sign, while the second to ninth bits store the exponent, and the rest bits store the mantissa. When the second to ninth bits “01111101” is larger than the exponent threshold, the mantissa “00111001000010010110110” is regarded as valid and is stored into the 10th to 32nd bits. In this way, when this floating point number operates with other floating point numbers in follow-up processes, the mantissa will be actually used.

In another example, the decimal value “-0.002” is converted into a binary floating point number “10111011000000110001001001101111”, in which the first bit from the most significant bit stores “1” to indicate the sign, while the second to ninth bits store the exponent and the remaining bits store the mantissa. When the second to ninth bits “01110110″is smaller than the exponent threshold, the mantissa “00000110001001001101111” is regarded as insignificant and thus will not be stored, so that the 10th to 32nd bits will be empty in this situation. As a result, when this floating point number is operated with other floating point numbers in a follow-up process, the mantissa will not participate in operations. In other words, when the exponent is smaller than the exponent threshold in a floating point number, it can be determined that value of the floating point number is small enough. In this way, under the situation where the mantissa of the floating point number is ignored, the floating point number can be decoded as the follows:

$${\left(\text{-1}\right)}^{\text{Sign}} \times {\text{2}}^{\text{Exponent}}$$

where not all bits of mantissa have to involve in calculations or be sent to a register, thus saving the power consumption and time for transmission. In some cases, even the mantissa may also not be stored in the memory, which can further save more storage space. In another embodiment, at least one bit of the mantissa does not participate in calculation and is not transmitted into a register and/or a memory, so as to further save storage space.

In yet another example, the decimal value “0.003” is converted into a binary floating point number, i.e., “00111011010001001001101110100110”, in which the first bit from the most significant bit stores “0” to indicate the sign, the second to ninth bits store the exponent, and the remaining bits store the mantissa. When the second to ninth bits “01110110” is smaller than the exponent threshold, the mantissa “10001001001101110100110” can be negligible, but is still stored in the 10th to 32nd bits and marked as “Don’t care”. In this way, when this floating point number is operated with other floating point numbers, the mantissa will not participate in the calculation. The difference between this example and the previous example is that the mantissa in this example can exist without being decoded nor operated, so as to further save the operational power consumption and save time for data transmission. Similarly, in the example of FIG. 3, the total number of the sign bit, exponent bit and mantissa bit may be 8-64 bits, but the present invention is not limited thereto. The total number of the above bits can also be smaller than 8 bits, e.g., 7 bits.

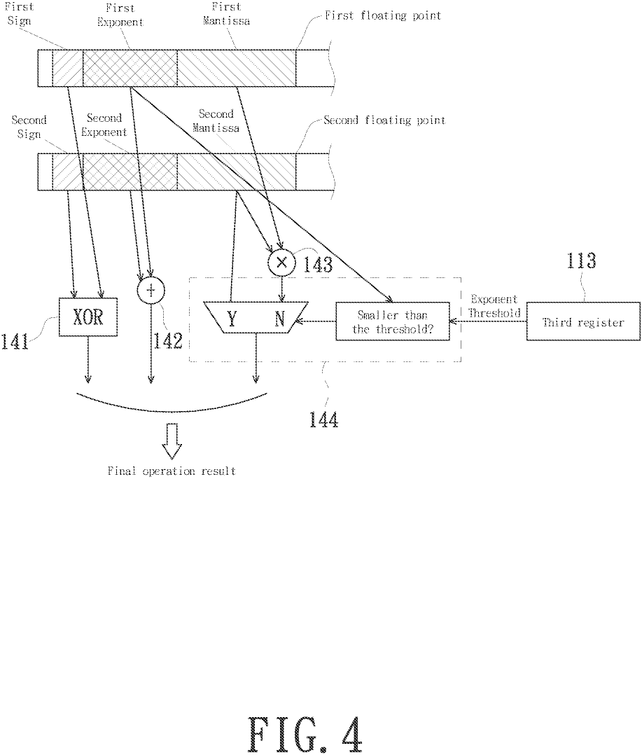

Please refer to FIG. 4, which is a diagram illustrating the architecture of an arithmetic unit for multiplying two floating point numbers according to an embodiment of the present invention. As mentioned above, the first floating point number can be extracted from the first register 111, the second floating point number can be extracted from the second register 112, and the exponent threshold can be extracted from the third register 113. The first register comprises a first sign bit storing the first sign (i.e., the sign corresponding to the first floating point number), an exponent bit storing the first exponent, and a mantissa bit storing the first mantissa. The second register comprises a second sign bit storing the second sign, an exponent bit storing the second exponent, and a mantissa bit storing the second mantissa respectively.

When processing the multiplication operation between the first register 111 and the second register 112, the arithmetic unit 110 compares the first exponent with the exponent threshold through the comparison logic 144, wherein when the first exponent is not smaller than the exponent threshold, which indicates that the number representing the first floating point number is relatively large and thus the effective digit of the mantissa cannot be ignored, the multiplication logic 143 will multiply the first mantissa by the second mantissa to generate the mantissa operation result (i.e., the output of the comparison logic 144). If the first exponent is smaller than the exponent threshold, which indicates that the number of the first floating point number is relatively small, the mantissa significant digits can be ignored. Then, after discarding at least one bit (such as one or more bits), the first mantissa is multiplied by the second mantissa to obtain the mantissa operation result. This step may comprise discarding just one bit or several bits, or even all bits (i.e., ignoring the whole first mantissa, which is equivalent to directly generating the mantissa operation result according to the second mantissa). Preferably, discarding the whole first mantissa can reduce more power consumption. However, if there is a demand for higher precision, the goal of reducing the power consumption can be achieved even by discarding only one bit. In addition, the XOR operation between the first sign and the second sign can be performed by the XOR logic 141 to generate a sign operation result (i.e., the output of the XOR logic 141), and the first exponent can be added to the second exponent by the addition logic 142 to generate an exponent operation result (i.e., the output of the addition logic 142). Finally, a calculated floating point number is generated according to the mantissa operation result, the sign operation result and the exponent operation result, and serves as the final operation result. When the first exponent is smaller than the exponent threshold, the first floating point number is decoded into “(-1)^{Sign1} × 2^{Exponent1}”, where Sign1 denotes the first sign, and Exponent1 denotes the first exponent. Similarly, in addition to comparing the first exponent with the exponent threshold, this embodiment can further compare the second exponent with the exponent threshold. When the second exponent is smaller than the exponent threshold the second floating point number is decoded into “(-1)^{Sign2} × 2^{Exponent2}”, where Sign2 denotes the second sign and Exponent2 denotes the second exponent. In this embodiment, the illustrated XOR logic 141, addition logic 142, multiplication logic 143 and comparison logic 144 are merely for illustrative purposes. The exact ways of implementation may base on the actual needs, and can be different from what shown in this embodiment. However, the present invention comprises all possible details adjustment without additional restrictions. In an example of the present invention, the multiplication logic 143 of a single-precision floating-point arithmetic unit may interpret the mantissa in the form of “l.Mantissa”, where “l” on the left of the decimal point is an integer, and “Mantissa” on the right of the decimal point denotes the mantissa. In addition, the addition logic 142 of the single-precision floating-point arithmetic unit interprets Exponent as “Exponent - 127” (referred to as “Exponent minus 27”), and then perform the addition operations, but the present invention is not limited thereto. Although the above mostly relates to simplification of the storing and transmission of the first mantissa, the same concept can also be applied to the second mantissa. For example, the roles of the above-illustrated first and second mantissas can be interchanged, or the simplification of the storing and transmission can be performed on both of the first and second mantissas.

According to different embodiments of the present invention, the exponent threshold may be a fixed value, or dynamically adjustable. With the design of an adjustable threshold, the desired precision of floating-point operations can be selected. For example, if the threshold is large, there will be more mantissas that are not decoded, and thus the power consumption of data transmission and operation can be greatly reduced. The exponent threshold can be dynamically adjusted according to the temperature of the arithmetic unit 110 and/or the type of the tasks to be processed by the arithmetic unit 110. For example, when the current temperature of the arithmetic device 100 is too high and needs to be cooled down, the exponent threshold can be tuned up so that the arithmetic unit 110 can operate in a low power consumption and low temperature mode. In addition, when the arithmetic device 100 is a mobile device and does not have much power left, the exponent threshold can also be tuned up to extend the standby time of the mobile device. In addition, if the arithmetic unit 110 performs operations that require good precision, the exponent threshold can be tuned down so that more mantissas can be decoded, thereby improving the precision.

Selectively, according to the embodiment of the present invention, the exponent threshold is in a dynamically adjustable range. The arithmetic unit 110 starts training with an exponent threshold with a value of 1, and the arithmetic unit 110 determines a criteria whether the operation precision is higher than the precision threshold, and if the criteria is met, it tunes up the value of the exponent threshold until the operation precision is not higher than the precision threshold, and the dynamically adjustable range may be the exponent threshold that meets the conditions. The invention ignores the mantissas of the floating point numbers with small values, and decodes the mantissa of those with large values. Compared with the conventional techniques, the present invention can avoid over-designing the hardware architecture such that the hardware architecture design can be simplified, thus saving the power consumption and time of data storage and data transmission.

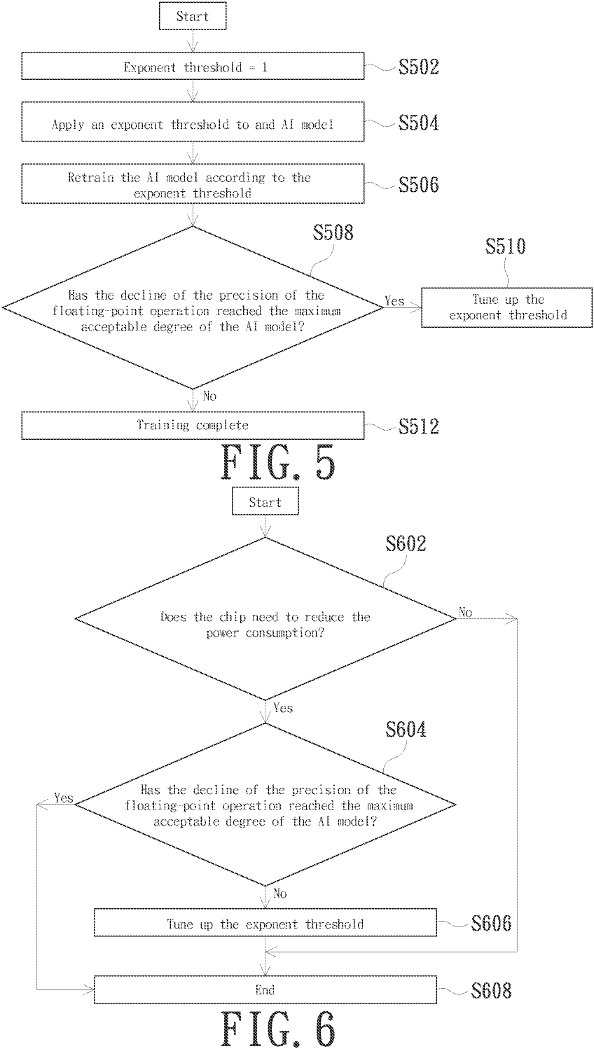

As can be seen from the above embodiments, since the arithmetic device 100 can be applied in different scenarios, how to properly select the exponent threshold is very important, which yields the optimal tradeoff between precision, power consumption and processing speed. If the present invention is applied to the artificial intelligence (AI) model, an appropriate exponent threshold can be calculated according to the current requirements of the arithmetic device 100. Please refer to FIG. 5, which is a flowchart of training artificial intelligence model by arithmetic unit 110 according to an embodiment of the present invention, which can be briefly summarized as follows:

Step S502: Set an initial value of the exponent threshold to 1.

Step S504: Apply an exponent threshold to the AI model.

Step S506: Retrain the AI model according to the exponent threshold.

Step S508: Determine whether the decline of the precision of the floating-point operation has reached the maximum acceptable degree of the AI model; if yes, the flow enters Step S510; if not, the flow enters Step S512.

Step S510: Tune up the exponent threshold.

Step S512: The training is completed.

To sum up, FIG. 5 illustrates a training scheme of a low power consumption mode. If it is determined in Step S508 that the decline of the precision of floating-point operation does not exceed the maximum acceptable decline degree of an AI model, it means that the precision of the floating-point operation is still higher than expected. In this sense, the exponent threshold can be raised without exceeding the fault tolerance, to further reduce the power consumption and processing time.

Please refer to FIG. 6, which is a flowchart of the arithmetic device 100 for reducing processing chip power consumption according to an embodiment of the present invention, which can be briefly summarized as follows:

Step S602: Determine whether the processing chip needs to reduce the power consumption; if yes, the flow enters Step S604; if not, the flow enters Step S608.

Step S604: Determine whether the decline of the precision of the floating-point operation has reached the maximum acceptable degree of the AI model; if not, the flow enters Step S606; if yes, the flow enters Step S608.

Step S606: Tune up the exponent threshold.

Step S608: The process ends.

To sum up, FIG. 6 illustrates a scheme for optimizing power consumption. Initially, it is determined in Step S602 whether there is a need to reduce the power consumption. Taking a smart phone as an example, if the smart phone is fully charged or intensively used, the power consumption will not be reduced. On the other hand, if the battery of the smart phone is insufficient, or the smart phone is in a low-level use state, the power consumption should be reduced. When it is determined that the processing chip needs to reduce power consumption, Step S604 determines the precision of the current floating-point operation. If the precision decline does not reach the maximum acceptable level of the AI model, it means that the precision of the current floating-point operation is still higher than expected. In this sense, the exponent threshold can be raised without exceeding the fault tolerance, to further reduce the power consumption and processing time.

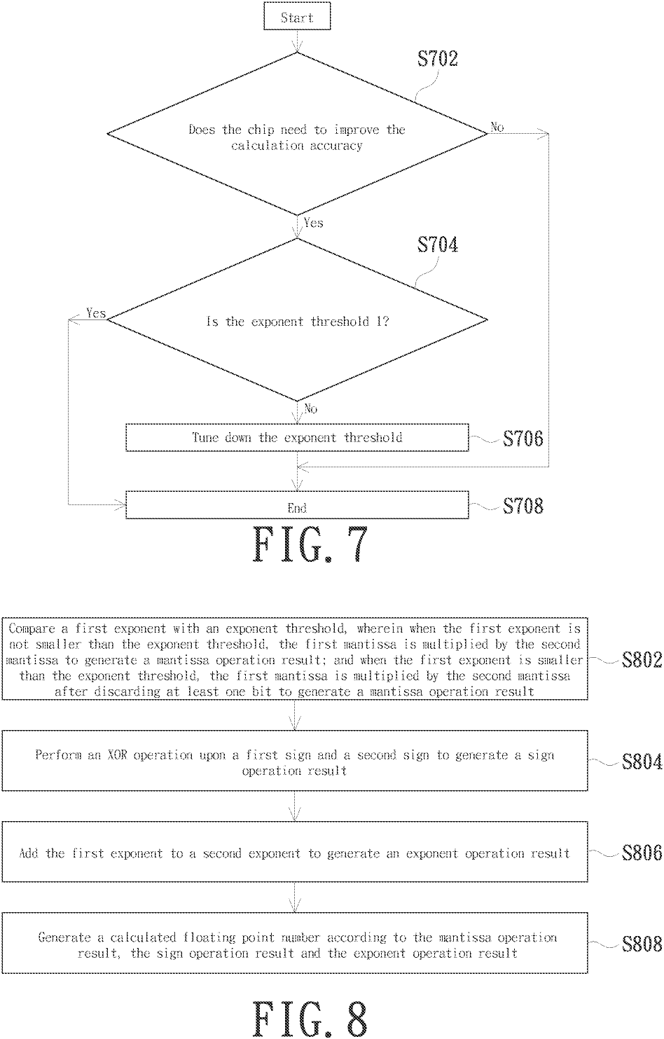

Please refer to FIG. 7, which is a flowchart of the arithmetic device 100 adaptively adjusting the processing chip power consumption while maintaining the precision according to an embodiment of the present invention, which can be briefly summarized as follows:

Step S702: Determine whether the calculation precision of the processing chip needs to be improved; if yes, the flow enters Step S704; if not, the flow enters Step S708.

Step S704: Determine whether the exponent threshold is 1 (i.e., the minimum value of the exponent threshold); if not, the flow enters Step S706; if yes, the flow enters Step S708.

Step S706: Tune down the exponent threshold.

Step S708: The process ends.

To sum up, FIG. 7 illustrates a precision-oriented power consumption adjustment scheme for floating-point operations. First, it is determined in Step S702 whether the precision of operations has been improved. Taking a smart phone as an example, if the smart phone is performing high-quality image processing, the processing chip will enter the Turbo mode without considering the power saving. On the other hand, if the smart phone is performing image recognition which does not require high precision, the processing chip can enter power saving. Next, Step S704 determines whether the exponent threshold is currently the minimum exponent threshold (the present invention takes 1 as an example, but it is not limited thereto), and if it is still not the minimum exponent threshold, Step S706 will be executed to perform the downward adjustment.

Please refer to FIG. 8, which is a flowchart of a floating-point calculation method according to an embodiment of the present invention. Please note that if substantially the same result can be obtained, these steps need not be executed in the execution order shown in FIG. 8. The floating-point calculation method shown in FIG. 8 can be adopted by the arithmetic device 100 or the arithmetic unit 110 shown in FIG. 1, and can be summarized as the following steps:

Step S802: Compare a first exponent with an exponent threshold, wherein when the first exponent is not smaller than the exponent threshold, the first mantissa is multiplied by the second mantissa to generate a mantissa operation result; and when the first exponent is smaller than the exponent threshold, the first mantissa is multiplied by the second mantissa after discarding at least one bit to generate a mantissa operation result.

Step S804: Perform an XOR operation upon a first sign and a second sign to generate a sign operation result.

Step S806: Add the first exponent to a second exponent to generate an exponent operation result; and

Step S808: Generate a calculated floating point number according to the mantissa operation result, the sign operation result and the exponent operation result.

Since those skilled in the art can easily understand the details of each step in FIG. 8 after reading the above paragraphs, more detailed description thereof is omitted here for brevity.

In view of the above, once the exponent value of a floating point number is smaller than the threshold value, the present invention may discard the mantissa (i.e., the mantissa will not be stored in a memory) to further save storage space, or only store the mantissa without involving in decoding and operation, so as to save the time and effort for data transmission and the operational power consumption. In addition, through the adjustability of the threshold(see the optimization flow in FIGS. 5 to 7 for details), the corresponding electronic product can flexibly make a tradeoff between the high-performance mode and the low-power mode (e.g., if the threshold is high, there will be more mantissas that will not be decoded, and the data transmission and operational power consumption can be thus reduced), so that the present invention can save power consumption and increase the processing speed under while keeping the required operation precision.

What is claimed is:

1. A floating-point calculation method applicable to multiplication between a first register and a second register, wherein the first register stores a first floating point number, and the second register stores a second floating point number; the first register comprises a first exponent bit(s) storing a first exponent, and a first mantissa bit(s) storing a first mantissa; the second register comprises a second exponent bit(s) storing a second exponent, and a second mantissa bit(s) storing a second mantissa; and the method comprises using an arithmetic unit to perform following steps:
comparing the first exponent with an exponent threshold, wherein when the first exponent is not smaller than the exponent threshold, the first mantissa is multiplied by the second mantissa to generate a mantissa operation result; and when the first exponent is smaller than the exponent threshold, the first mantissa is multiplied by the second mantissa after at least one bit of the first mantissa is discarded, to generate the mantissa operation result;
adding the first exponent to the second exponent to generate an exponent operation result; and
generating a calculated floating point number according to the mantissa operation result and the exponent operation result.

2. The floating-point calculation method according to claim 1, wherein the first register further comprises a first sign bit storing a first sign, the second register further comprises a second sign bit storing a second sign, and the floating-point calculation method further comprises:
performing an XOR operation upon the first sign and the second sign to generate a sign operation result; and
generating the calculated floating point number according to the mantissa operation result, the sign operation result and the exponent operation result.

3. The floating-point calculation method according to claim 1, wherein the exponent threshold is stored in a third register, and the arithmetic unit accesses the third register when performing multiplication between the first register and the second register.

4. The floating-point calculation method according to claim 1, wherein when the first exponent is smaller than the exponent threshold, at least one bit of the first mantissa is temporarily stored without involving in arithmetic operations.

5. The floating-point calculation method according to claim 4, wherein the exponent threshold is dynamically adjustable.

6. The floating-point calculation method according to claim 5, wherein the exponent threshold is dynamically adjusted according to temperature of the arithmetic unit and/or types of tasks to be processed by the arithmetic unit.

7. The floating-point calculation method according to claim 4, wherein the exponent threshold is within a dynamically adjustable range, and the arithmetic unit starts training with an exponent threshold with a value of 1; the arithmetic unit determines a criteria whether an operation precision is higher than an precision threshold;
if the criteria is met, the value of the exponent threshold is increased until the operation precision is not higher than an precision threshold, and the dynamically adjustable range comprises the exponent threshold(s) that meets the criteria.

8. The floating-point calculation method according to claim 1, wherein the first register is coupled to a memory arranged to store the first exponent, and when the first exponent is smaller than the exponent threshold, at least one bit of the first mantissa is discarded without being stored in the memory.

9. The floating-point calculation method according to claim 1, wherein when the first exponent is smaller than the exponent threshold, at least one bit of the first mantissa is in a Don’t Care state.

10. The floating-point calculation method according to claim 1, wherein when the first exponent is smaller than the exponent threshold, the first floating point number is decoded into (-1)^{Sign1} × 2^{Exponent1}, where Sign1 denotes the first sign, and Exponent1 denotes the first exponent.

11. The floating-point calculation method according to claim 10, wherein when the second exponent is smaller than the exponent threshold, the second floating point number is decoded into (-1)^{Sign2} × 2^{Exponent2}, where Sign2 denotes the second sign, and Exponent2 denotes the second exponent.

12. The floating-point calculation method according to claim 1, further comprising accessing a memory using the arithmetic unit, wherein the memory stores a plurality of groups of batch normalization coefficients corresponding to a plurality of candidate thresholds respectively, and the exponent threshold is selected from one of the candidate thresholds.

13. An arithmetic unit coupled to a first register and a second register,
wherein the first register stores a first floating point number, and the second register stores a second floating point number; the first register comprises a first exponent bit(s) storing a first exponent, and a first mantissa bit(s) storing a first mantissa; the second register comprises a second exponent bit(s) storing a second exponent, and a second mantissa bit(s) storing a second mantissa;
and when performing multiplication between the first register and the second register, the arithmetic unit performs following steps:
comparing the first exponent with an exponent threshold, wherein when the first exponent is not smaller than the exponent threshold, the first mantissa is multiplied by the second mantissa to generate a mantissa operation result; and when the first exponent is smaller than the exponent threshold, the first mantissa is multiplied by the second mantissa after at least one bit of the first mantissa is discarded to generate the mantissa operation result;
adding the first exponent to the second exponent to generate an exponent operation result; and
generating a calculated floating point number according to the mantissa operation result and the exponent operation result.

14. The arithmetic unit according to claim 13, wherein the first register further comprises a first sign bit storing a first sign; the second register further comprises a second sign bit storing a second sign, and the arithmetic unit further performs following steps:
performing an XOR operation upon the first sign and the second sign to generate a sign operation result; and
generating the calculated floating point number according to the mantissa operation result, the sign operation result and the exponent operation result.

15. The arithmetic unit according to claim 13, wherein the exponent threshold is stored in a third register, and the arithmetic unit accesses the third register when performing multiplication between the first register and the second register.

16. The arithmetic unit according to claim 13, wherein when the first exponent is smaller than the exponent threshold, at least one bit of the first mantissa is temporarily stored without involving in any arithmetic operations.

17. The arithmetic unit of claim 16, wherein the exponent threshold is dynamically adjustable.

18. The arithmetic unit according to claim 17, wherein the exponent threshold is dynamically adjusted according to temperature of the arithmetic unit and/or types of tasks to be processed by the arithmetic unit.

19. The arithmetic unit according to claim 16, wherein the exponent threshold is in a dynamically adjustable range, the arithmetic unit performs training with an exponent threshold with a value of 1; and the arithmetic unit determines a criteria whether the operation precision is higher than an precision threshold, and if the criteria is met, the value of the exponent threshold is increased until the operation precision is not higher than an precision threshold, and the dynamically adjustable range comprises the exponent threshold(s) that meets the criteria.

20. The arithmetic unit of claim 13, wherein when the first exponent is smaller than the exponent threshold, the first floating point number is decoded into (-1)^{Sign1} × 2^{Exponent1}, where Sign1 denotes the first sign, and Exponent1 denotes the first exponent.

21. The arithmetic unit according to claim 20, wherein when the second exponent is smaller than the exponent threshold, the second floating point number is decoded into (-1)^{Sign2} × 2^{Exponent2}, where Sign2 denotes the second sign, and Exponent2 denotes the second exponent.

22. The arithmetic unit according to claim 13, wherein the first register and the second register are coupled to a memory arranged to store a plurality of sets of batch normalization coefficients corresponding to a plurality of candidate thresholds respectively, and the exponent threshold is selected from one of the candidate thresholds.

23. An arithmetic device comprising a first register, a second register and an arithmetic unit, wherein the arithmetic unit is coupled to the first register and the second register, and the first register stores a first floating point number and the second register stores a second floating point number; the first register comprises a first exponent bit(s) storing a first exponent, and a first mantissa bit(s) storing a first mantissa; the second register comprises a second exponent bit(s) storing a second exponent, and a second mantissa bit(s) storing a second mantissa; wherein when performing multiplication between the first register and the second register, the arithmetic unit performs following steps:
comparing the first exponent with an exponent threshold, wherein when the first exponent is not smaller than the exponent threshold, the first mantissa is multiplied by the second mantissa to generate a mantissa operation result; when the first exponent is smaller than the exponent threshold, the first mantissa is multiplied by the second mantissa after at least one bit of the first mantissa is discarded, to generate the mantissa operation result;
adding the first exponent to the second exponent to generate an exponent operation result; and
generating a calculated floating point number according to the mantissa operation result and the exponent operation result.
